(19) United States
(12) Patent Application Publication
(10) Pub. No.: US 2023/0266142 A1
(43) Pub. Date: Aug. 24, 2023

(54) METHOD, APPARATUS, AND SYSTEM FOR RECONSTRUCTING A ROAD LINEAR FEATURE

(71) Applicant: HERE Global B.V., Eindhoven (NL)

(72) Inventors: Zhenhua ZHANG, Chicago, IL (US); Qi MAO, Arlington, TX (US); Lin GAN, Chicago, IL (US); Xiaoying JIN, Boulder, CO (US); Sanjay Kumar BODDHU, Aurora, IL (US)

(21) Appl. No.: 17/678,597

(22) Filed: Feb. 23, 2022

(51) Int. Cl. G01C 21/00

(52) U.S. Cl. CPC G01C 21/3822; G01C 21/3859

(57) ABSTRACT

An approach is provided for reconstructing a road linear feature. The approach, for example, involves receiving two or more linear feature detections that respectively represent a linear feature of a road as a line segment delimited by two feature points. The approach also involves map matching the two or more linear feature detections to a road link segment of a geographic database. The approach further involves determining an orientation difference for each of the two or more linear feature detections based on an angle difference between each linear feature detection and a link orientation of the map matched road link segment. The approach further involves determining a feature orientation of the linear feature based on an aggregation of the orientation difference for each linear feature detection. The approach further involves constructing a representation of the linear feature based at least in part on the feature orientation.

### BACKGROUND

Navigation and mapping service providers are continually challenged to provide users up-to-date digital map data. One particular area of interest is the use of computer vision to enable mapping and sensing of road networks in an environment (e.g., to support autonomous or semi-autonomous operation or other location-based applications). For example, one application of vision techniques is mapping or vehicle localization with respect to known linear features of a road such as lane markings, medians, and/or other visible line-like environmental features. However, each detection of linear feature of a road can be incomplete, subject to error (e.g., positioning or heading error), and/or the like. As a result, service providers face significant technical challenges to generate a representation of a road linear feature from multiple detections of the feature.

### SOME EXAMPLE EMBODIMENTS

Therefore, there is a need for providing consistent and accurate reconstruction of a linear road feature from multiple detections of the feature.

According to one embodiment, a method comprises receiving two or more linear feature detections that respectively represent a linear feature of a road as a line segment delimited by two feature points. The method also comprises map matching the two or more linear feature detections to a road link segment of a geographic database. The method further comprises determining an orientation difference for each of the two or more linear feature detections. The orientation difference, for instance, is an angle difference between each of the two or more linear feature detections and a link orientation of the map matched road link segment. The method further comprises determining a feature orientation of the linear feature based on an aggregation of the orientation difference for each of the two or more linear feature detections. The method further comprises constructing a representation of the linear feature based at least in part on the feature orientation.

According to another embodiment, an apparatus comprises at least one processor, and at least one memory including computer program code for one or more computer programs, the at least one memory and the computer program code configured to, with the at least one processor, cause, at least in part, the apparatus to receive two or more linear feature detections that respectively represent a linear feature of a road as a line segment delimited by two feature points. The apparatus is also caused to map match the two or more linear feature detections to a road link segment of a geographic database. The apparatus is further caused to determine an orientation difference for each of the two or more linear feature detections. The orientation difference, for instance, is an angle difference between each of the two or more linear feature detections and a link orientation of the map matched road link segment. The apparatus is further caused to determine a feature orientation of the linear feature based on an aggregation of the orientation difference for each of the two or more linear feature detections. The apparatus is further caused to construct a representation of the linear feature based at least in part on the feature orientation.

According to another embodiment, a computer-readable storage medium carries one or more sequences of one or more instructions which, when executed by one or more processors, cause, at least in part, an apparatus to receive two or more linear feature detections that respectively represent a linear feature of a road as a line segment delimited by two feature points. The apparatus is also caused to map match the two or more linear feature detections to a road link segment of a geographic database. The apparatus is further caused to determine an orientation difference for each of the two or more linear feature detections. The orientation difference, for instance, is an angle difference between each of the two or more linear feature detections and a link orientation of the map matched road link segment. The apparatus is further caused to determine a feature orientation of the linear feature based on an aggregation of the orientation difference for each of the two or more linear feature detections. The apparatus is further caused to construct a representation of the linear feature based at least in part on the feature orientation.

In addition, for various example embodiments described herein, the following is applicable: a computer program product may be provided. For example, a computer program product comprising instructions which, when the program is executed by a computer, cause the computer to perform any one or any combination of methods (or processes) disclosed.

According to another embodiment, an apparatus comprises means for receiving two or more linear feature detections that respectively represent a linear feature of a road as a line segment delimited by two feature points. The apparatus also comprises means for map matching the two or more linear feature detections to a road link segment of a geographic database. The apparatus further comprises means for determining an orientation difference for each of the two or more linear feature detections. The orientation difference, for instance, is an angle difference between each of the two or more linear feature detections and a link orientation of the map matched road link segment. The apparatus further comprises means for determining a feature orientation of the linear feature based on an aggregation of the orientation difference for each of the two or more linear feature detections. The apparatus further comprises means for constructing a representation of the linear feature based at least in part on the feature orientation.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of reconstructing linear features of a road, according to one example embodiment;

FIG. 2A is a diagram illustrating detections of linear features of a road using on-board vehicle camera sensors according to one example embodiment;

FIG. 2B is a diagram illustrating an example of good and bad detections of linear features of road, according to one example embodiment;

FIG. 3 is a diagram of components of a mapping platform capable of reconstructing linear features of a road, according to one example embodiment;

FIG. 4 is a flowchart of a process for reconstructing linear features of a road, according to one example embodiment;

FIG. 5 is a diagram illustrating example linear feature groupings, according to one example embodiment;

FIG. 6 is a diagram illustrating an example of linear orientation estimation, according to one example embodiment;

FIGS. 7A and 7B are diagrams illustrating an example of linear feature location estimation, according to one example embodiment;

FIG. 8 is a diagram illustrating an example of constructing a representation of a linear feature based on estimated orientation and/or location data, according to one example embodiment;

FIG. 9 is a diagram of a geographic database, according to one embodiment;

FIG. 10 is a diagram of hardware that can be used to implement an embodiment;

FIG. 11 is a diagram of a chip set that can be used to implement an embodiment; and

FIG. 12 is a diagram of a mobile terminal (e.g., handset or vehicle or part thereof) that can be used to implement an embodiment.

### DESCRIPTION OF SOME EMBODIMENTS

Examples of a method, apparatus, and computer program for reconstructing linear features of a road are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

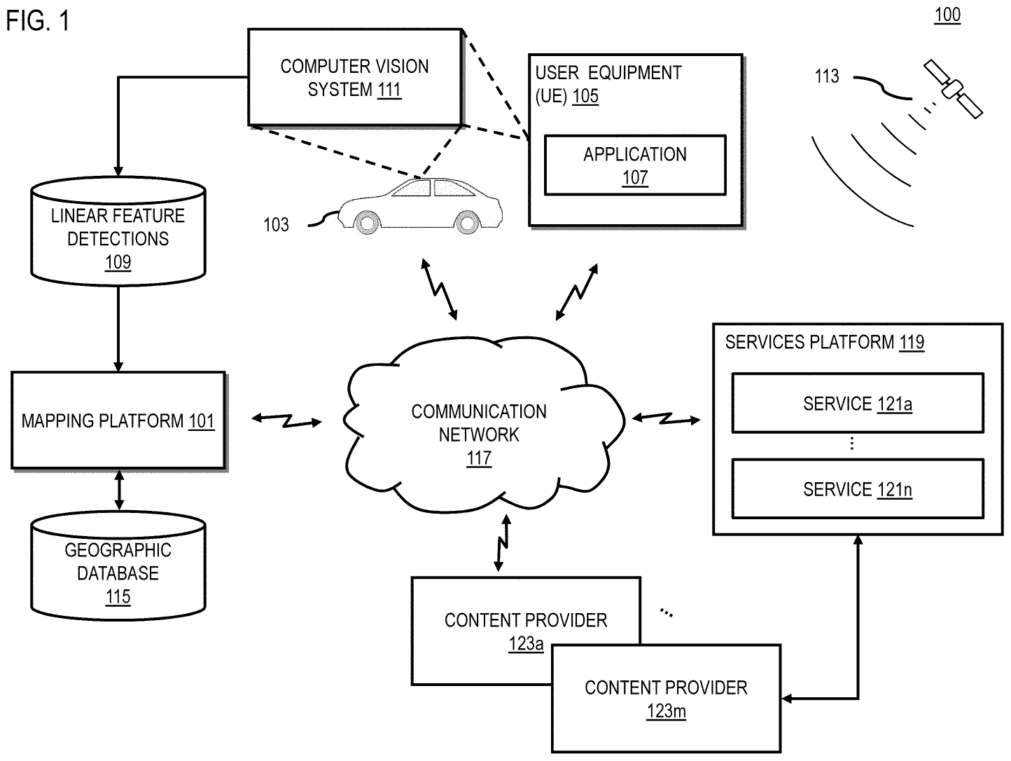

FIG. 1 is a diagram of a system 100 capable of reconstructing linear features of a road, according to one example embodiment. Mapping and navigation service providers (e.g., operators of a mapping platform 101) face significant technical challenges with respect to generating accurate maps of cartographic features that can be used to facilitate applications such as, but not limited, autonomous driving, lane-level localization, lane-level navigation routing, and/or the like. One class of cartographic features that is of interest for such applications includes linear features of a road. This is because linear features often define boundaries of a road or one or more lanes of the road. Thus, by mapping such linear features, mapping and navigation service providers enable vehicles 103 (e.g., autonomous, semi-autonomous, and/or manually operated vehicles) to have situational awareness of their locations relative to these linear features (e.g., to detect when they are driving within the boundaries or lanes of a road or segment thereof). By way of example, a linear feature may correspond to or otherwise indicate a border of the road link segment (and/or a border of a lane of the link segment), where the border may be represented by one or more of lane markings, guardrails, road curbs, road medians, road barriers, and/or the like. In other examples, the linear feature can also be any line-based object or road furniture (e.g., an object whose dimensions can be represented as a line segment or polyline) occurring on or within a threshold proximity of the road. For example, a line-based object can include, but is not limited to, fences, overhead power lines, linearly arranged lights, and/or the like. In yet another example, a linear feature can be a vehicle path (also referred to as a drive path) on the road link segment where the vehicle path is described by a sequence of two or more location data points determined using a positioning sensor of the vehicle 103 or other mobile device as it travels or drives.

In various example embodiments, vehicles 103, user equipment (UE) devices 105 (e.g., executing respective applications 107 for generating and reporting linear feature detections 109 from sensor data/image data), and/or any other devices capable of traveling over a road network can be used to collect linear feature detections 109 for reconstructing linear features of a road. For example, a computer vision system 111 (e.g., system comprising cameras and object recognition systems or equivalent) or equivalent on-board cameras of vehicles 103 and/or UEs 105 can detect road linear features such as, but not limited to, lane markings, road boundaries, medians, curbs, and/or the like. These features define the bounds of drive lanes and are useful components in the lane-based autonomous driving or other equivalent location-based applications. Various example embodiments are provided for determining, from vehicle sensor data (e.g., image data, GPS locations), the plurality of linear feature detections 109 associated with a road link segment. For instance, the linear feature detections may correspond to sensor observations (e.g., image data) that are indicative of a linear feature. In one example embodiment, a linear feature detection can represent a road linear feature (or portion thereof) as a line segment delimited by two feature points (e.g., end points of the line segment) corresponding to points on the linear feature detected from the image data (or other equivalent sensor data).

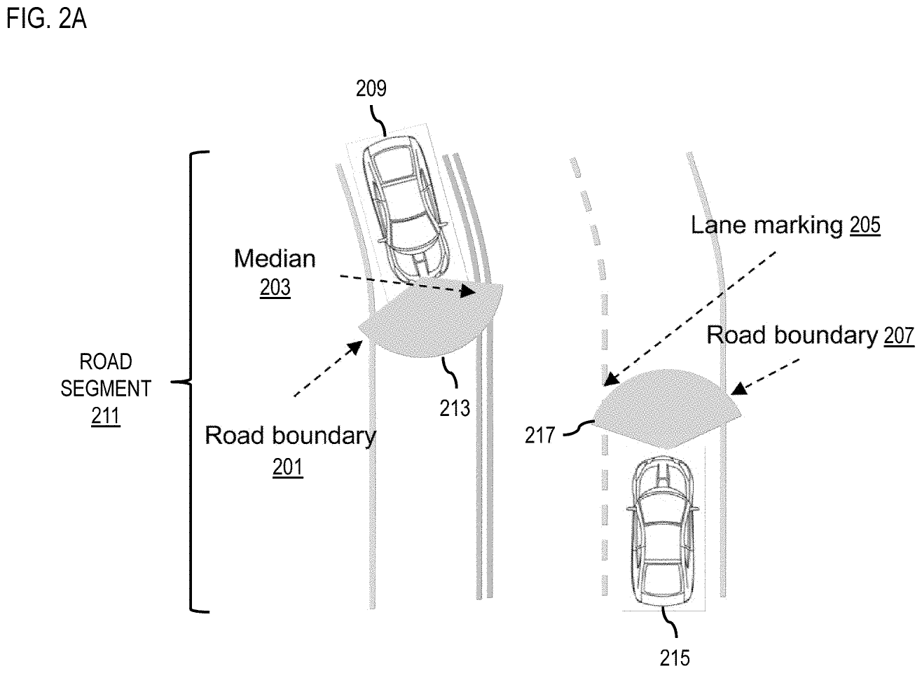

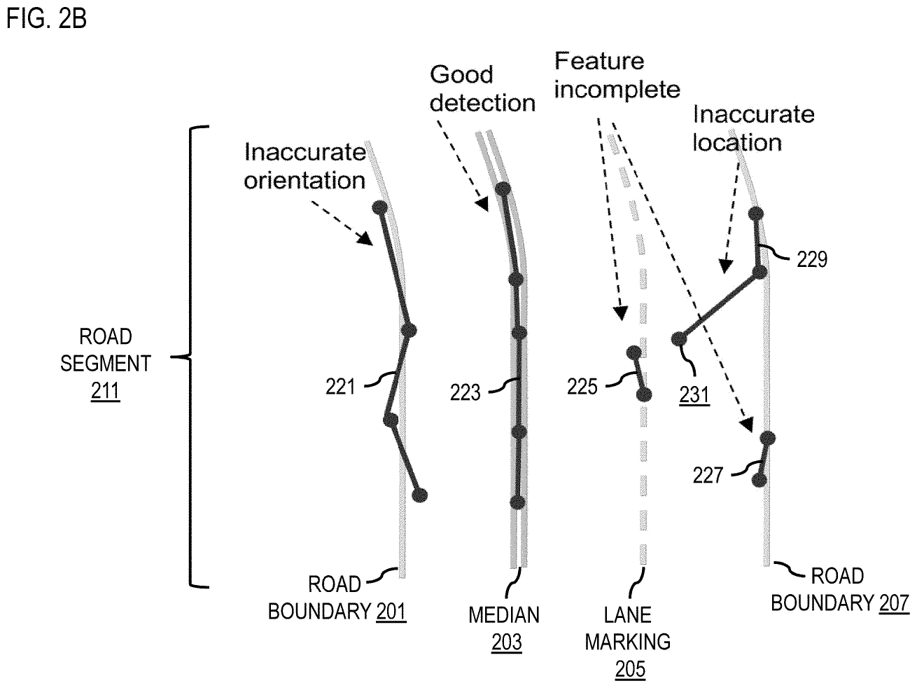

FIGS. 2A and 2B are diagrams illustrating an example of collecting linear feature detections, according to one example embodiment. It is noted that the example linear features (e.g., road boundary 201, median 203, lane marking 205, and road boundary 207) depicted in FIGS. 2A and 2B are provided by way of illustration and not as limitations. Accordingly, it is contemplated that any type of linear feature associated with a road link segment can be used according to the various embodiments described herein. As shown in FIG. 2A, a vehicle 209 is traveling on a road segment 211 and captures imagery 213 that depicts road boundary 201 and median 203. Another vehicle 215 is traveling in the opposite direction and captures imagery 217 that depicts lane marking 205 and road boundary 207.

As shown in FIG. 2B, in one example embodiment, the imagery 213 captured by vehicle 209 can be processed (e.g., via the computer vision system 111 or equivalent feature detector/object recognition system) to generate linear feature detections 221 and 223 respectively representing the road boundary 201 and median 203 that are visible in the imagery 213. The linear feature detections 221 and 223 are represented as one or more line segments respectively delimited by the detected locations of two feature points on the linear feature. For example, the detected locations are GPS locations or any other equivalent location data points determined using a positioning system associated with the vehicle 103 and/or UE 105 such as but not limited a satellite-based positioning system 113 or equivalent. Similarly, the imagery 217 captured by vehicle 215 can be processed to generate linear feature detections 225 representing lane marking 205 and linear feature detections 227 and 229 representing road boundary 207.

In the example, of FIG. 2B, the linear detections 221-229 having different quality levels of detection. For example, linear feature detection 221 has inaccurate orientation thereby resulting in a zig-zag shape that does not accurately represent the smooth contour of the road boundary 201 (e.g., line segment angles of the linear feature detection 221 do not match the angle/orientation of road boundary 201 within threshold criteria). Linear feature detection 223 is a “good detection” because its feature points fall on the linear feature (e.g., median 203) and its orientation matches the orientation of median 203 within threshold criteria. Linear feature detection 225 is considered “feature incomplete” because it represents less than a threshold portion of the lane marking 205 over an extent of the road segment 211. Similarly, linear feature detection 227 is also considered “feature incomplete” with respect to road boundary 207. Linear feature detection 229 is also associated with road boundary 207 and is considered as having “inaccurate location” because one of its feature point 231 is located more than distance threshold from a location of the road boundary 207.

As illustrated in FIG. 2B (e.g., showing good and bad linear feature detections), the performance of the linear feature detection may be affected by partial occlusion, equipment malfunction, reflection, etc. The detection results may often have issues such as detection incompleteness, inaccurate orientation, and location, etc. In addition, the feature points of the linear feature detections are often unordered, meaning that no time sequence or order of its constituent feature points (e.g., location data points) are available to determine a clear driving direction. For example, while the location of any two feature points of the linear feature detections may be known, it is not known whether the direction of travel is from the first point to the second point or vice versa.

Accordingly, mapping and navigation service providers face significant technical challenges with respect to how to derive linear features with good coverage and location accuracy for potentially inaccurate/incomplete and unordered linear feature detections 109. In particular, the technical challenge further relates to how to make the derived linear features ready safety critical applications such as but not limited to autonomous driving applications that depend on high accuracy linear feature data.

To address these technical challenges, the system 100 of FIG. 1 introduces a capability to estimate the orientation and/or location of a linear by map matching the linear feature detections to road link segment records of a geographic database 115 (or equivalent digital map data) with known orientations and/or locations to offset the effects of driving direction. In one example embodiment, the system 100 generalizes the road linear features into point-based vector features, aggregates the input linear feature detections, and reconstructs the linear features for lane marking, road boundary, etc. based on the feature orientations and locations estimated from the aggregated linear feature detections and known from the map data of the geographic database 115. More specifically, in one example embodiment, the orientation of the linear feature is estimated based on an angle difference of each linear feature detection on a given road link segment from the known orientation of the map matched road link segment determined from the geographic database 115.

In one example embodiment, the output of the system 100 (e.g., linear feature representations stored in the geographic database 115) can be widely used in location-based applications and services. For example, the linear feature representations generated according to the various example embodiments described herein are stored in the geographic database 115 for access by one or more other component of the system 100 or any other component with connectivity to the mapping platform 101 and/or geographic database 115. For example, the linear feature representations stored in the geographic database 115 can be accessed over the communication network 117 by the vehicle 103 for autonomous driving applications, lane-level navigation, lane-level positioning, and/or the like. In another example embodiment, a services platform 119, one or more services 121a-121n (also collectively referred to as services 121), and/or one or more content providers 123a-123m (also collectively referred to as content providers 123) can access the linear feature representations of the geographic services to perform one or more functions (e.g., location-based functions).

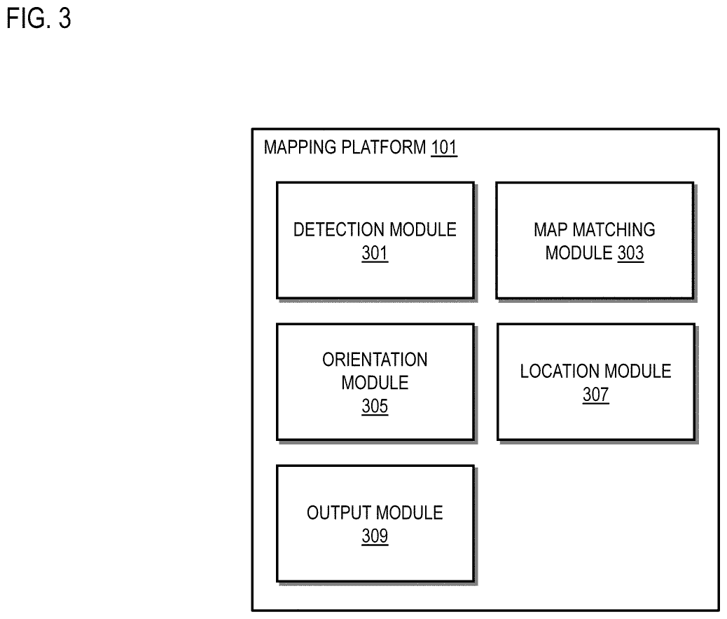

FIG. 3 is a diagram of components of a mapping platform capable of reconstructing linear features of a road, according to one example embodiment. In one embodiment, as shown in FIG. 3, the mapping platform 101 includes one or more components for reconstructing road linear features according to the various example embodiments described herein. As shown, in one example embodiment, the mapping platform 101 includes a detection module 301, a map matching module 303, an orientation module 305, a location module 307, and an output module 309. The above presented modules and components of the mapping platform 101 can be implemented in hardware, firmware, software, or a combination thereof. Though depicted as a separate entity in FIG. 1, it is contemplated that the mapping platform 101 may be implemented as a module of any of the components of the system 100 (e.g., a component of the services platform 119, services 121, content providers 123, vehicle 103, UE 105, computer vision system 111, application 107, and/or the like). In another embodiment, one or more of the modules 301-309 may be implemented as a cloud-based service, local service, native application, circuitry, or combination thereof.

As used herein, the term “circuitry” may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

The functions of the mapping platform 101 and modules 301-309 are discussed with respect to the figures discussed below.

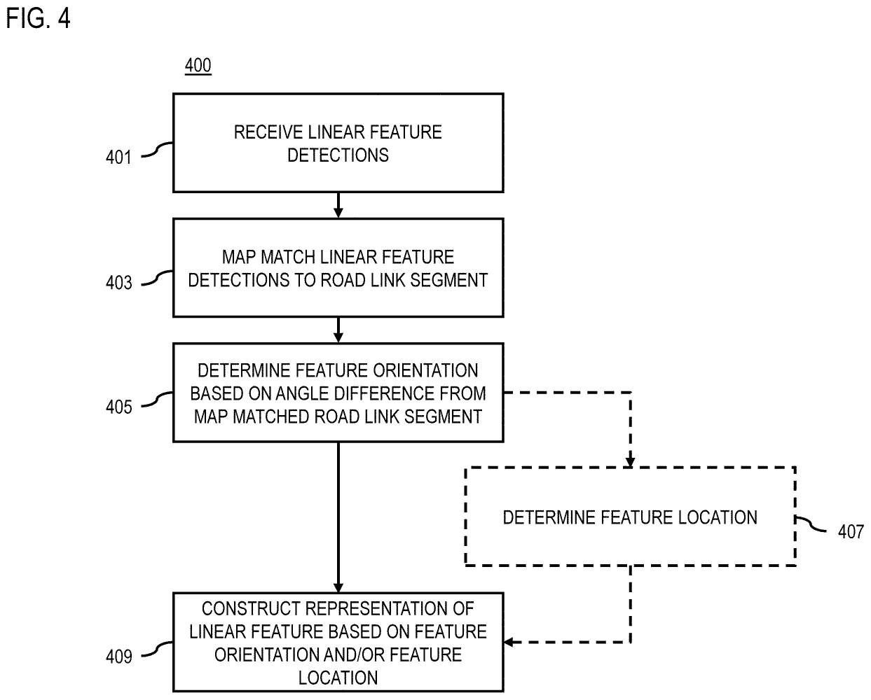

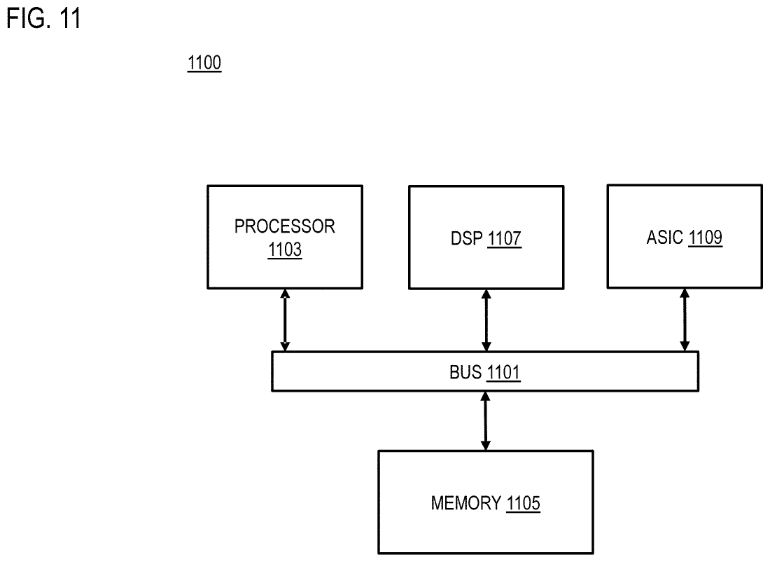

FIG. 4 is a flowchart of a process for reconstructing linear features of a road, according to one example embodiment. In various embodiments, the mapping platform 101 and/or any of the modules 301-309 may perform one or more portions of the process 400 and may be implemented in, for instance, a chip set including a processor and a memory as shown in FIG. 11. As such, the mapping platform 101 and/or any of the modules 301-309 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In step 401, the detection module 301 receives or otherwise determines two or more linear feature detections 109 that respectively represent a linear feature of a road as a line segment delimited by two feature points. By way of example, the linear feature can include, but is not limited to, a road boundary, a road lane marking, a road median, a road curb, a road barrier, a guardrail, a vehicle path, or a combination thereof. In one example embodiment, a linear feature detection 109 comprises at least one set of two feature points indicating a line segment that represents the locations and/or orientations of a detected linear feature.

A feature point can be any detected location on the linear feature. For example, imagery is captured by a vehicle 103 and/or UE 105 to detect and map linear features of a road 603. A linear feature is detected using the computer vision system 111. The computer vision system 111, for instance, employs a neural network (e.g., a convolutional neural network) or equivalent to recognize and determine feature data points corresponding to the linear feature. The imagery is captured by a camera system of a vehicle 103 and/or UE 105 as raster images at a predetermined pixel resolution. In one example embodiment, the imagery can be captured using cameras sensitive to visible light, infra-red, and/or any other wavelength of light. To support real-time operation, the imagery can be part of an image stream captured at a relatively high frequency (e.g., 20 Hz, 30 Hz, or higher).

Each image or frame of the image stream can then be processed to provide detection of linear features (e.g., in real-time or as a batch process). To detect a linear feature, the computer vision system 111 uses object recognition image processing to identify pixels of the image corresponding to surfaces or other visual features of the linear feature (e.g., painted surfaces for lane markings or road boundaries, structures associated with medians/curbs/sidewalks/etc., and/or the like). The detected positions of the selected feature points of linear features can be determined relative to the sensed position (e.g., GPS position) of the vehicle 103 or UE 105 traveling the road segment. The output of the detection process is one or more sets of line segments delimited by detected feature points of the linear feature. In some cases, as described above and depending on detection quality, the resulting linear feature detections may comprise a continuous or discontinuous set of line segments that represent the detected linear feature.

In summary, the general data features of line data in a linear feature detection 109 include, but is not limited to, one or more of the following:
(1) The line feature detection 109 are constituted by at least one set of two or more feature points (e.g., location data points such as GPS points or equivalent) such that each set of two feature points represent a segment of the linear feature as a line. Multiple sets of the feature points can then form a polyline representation of the linear feature detection 109. A location of a feature point, for instance, refers to a set of geocoordinates (e.g., latitude, longitude, and altitude) indicating a point location (e.g., a beginning, end, or other detected point of a line or linear feature).
(2) Each set of two or more feature points describes a line segment along the corresponding linear feature with or without heading information.
(3) Feature or location data points in each set is in sequence but may be without clear driving or travel direction, or the driving direction may not be consistent (e.g., when linear detections by multiple vehicles 103 traveling in opposite directions on a road).

Based on the above general data, the linear feature detections 109 can include location data points that are ordered (e.g., the location data points are received with a travel direction) or unordered (e.g., the location data points are received with no indication of a travel direction) and grouped into at least one set of location data points. Each set respectively represent a separate portion of the line feature.

In step 403, the map matching module 303 map matches the two or more linear feature detections 109 (e.g., received or determined in step 401) to a road link segment of a geographic database. It is contemplated that the map matching module 303 can use any map matching algorithm including but not limited to point-based map matching, path-based map matching, and/or the like. In one example embodiment, a linear feature detection 109 is associated with or otherwise detected on road represented by a map road link segment (e.g., stored in the digital map data of the geographic database 115). A “map road link segment” or “road link segment” refers to a map representation of a road or road segment stored as a road link data record of the geographic database 115 or equivalent digital map.

In one example embodiment, the map matching can be used to support grouping of the linear feature detections 109 according to road link segment. For example, each linear feature detection 109 can be matched to road centerline geometries (e.g., a node-link geometry) of the map data of the geographic database 115 based on their location and/or orientation information.

Since the linear features can span across a whole route constituted by both straight roads and curved roads, it can be technically challenging to quantify the location and orientation features over the whole route (e.g., because the orientation can vary over the whole route on a curved road or road that changes direction). Accordingly, in one example embodiment, one approach is to divide linear features on the whole route into smaller parts on different road link segments and generalize linear features on each link segment.

In one example embodiment, a map road link can include one or more shape points that can help to define the shape of map road link to more closely match the corresponding real world road segment. The one or more shape points are positioned at respective points along the map road link to delineate a plurality of link segments of the map road link. Each link segment defined by the shape points can have different headings to represent different contours of the road. The one or more feature points of a linear detection 109 can then be matched to respective link segments of the plurality of link segments (as opposed to matching against the entire map road link which can provide a coarser representation of the actual road).

In this way, linear feature detections 109 can be determined with respect to the respective link segments (e.g., associated with individual links of a whole route or with link segments described by shape points) for reconstructing linear features according to the various example embodiments described herein.

An example of this approach comprises at least one or more of the following steps:
(1) The linear feature detections 109 are first divided into singular parts constituted by only two locations or feature points. As described in the example embodiment above, a linear feature detection 109 can be an aggregation of multiple line segments respectively delimited by two feature points (e.g., a multi-segment polyline). In such as case, the multiple line segments can be divided into individual line segments with each line segment delimited by two feature points.
(2) Each location in the singular parts of the linear feature detections 109 is corresponded with a matched road link segment. In other words, each singular part of a linear feature detection 109 is map matched to a corresponding road link segment of the geographic database 115 (e.g., using any type of map matching algorithm or process).
(3) Those singular parts of the linear feature detections 109 whose two locations (e.g., feature points) are matched on different link segment groups are processed in both link segment groups. This is to keep location and orientation features of the linear feature detections in both link segments.

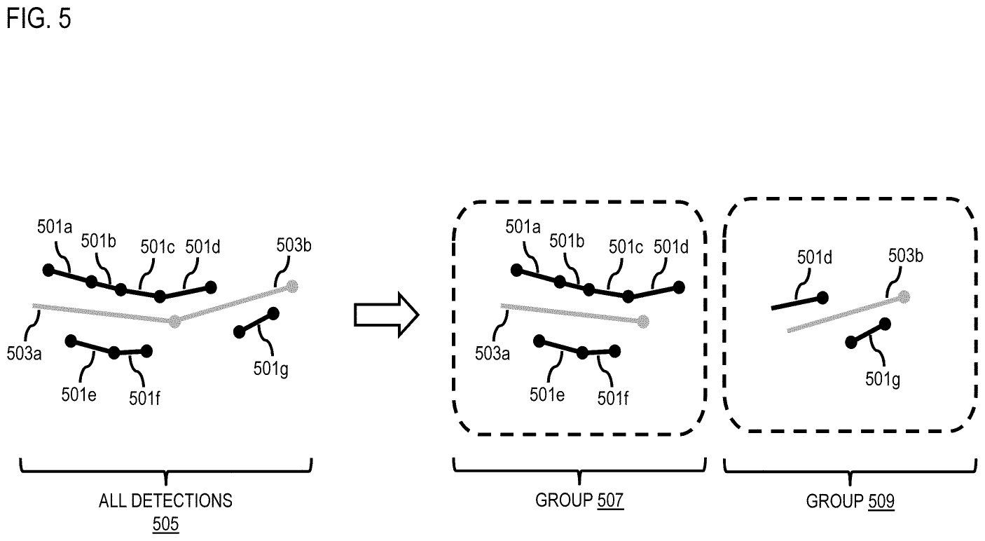

FIG. 5 is a diagram illustrating example linear feature groupings, according to one example embodiment. In the example of FIG. 5, the mapping platform 101 has received or otherwise determined linear feature detections 501a-501e (also collectively referred to as linear feature detections 501) associated with a route comprising map road link segments 503a and 503b. As shown, this initial set is referred to as all detections 505. The linear feature detections 501 are divided into singular linear feature detections 501a-501e such that each individual linear feature detection 501 comprises a line segment delimited by two feature points. The linear feature detections 501 are then grouped by map matching the feature points of each linear feature detection 501 to a corresponding map road link segment (e.g., either map road link segment 503a or map road link segment 503b). In this example, linear feature detections 501a-501c and 501e-501f are grouped into group 507 associated with map road link segment 503a because the two feature points of each linear feature detection 501a-501c and 501e-501f are map matched to map road link segment 503a. Similarly, linear feature detection 501g is grouped into group 509 associated with map road link segment 503b because its two feature points are map matched to map road link segment 503b. However, linear feature detection 501d is included in both groups 507 and 509 because its two feature points span both map road link segments 503a and 503b (e.g., a first feature point of the linear feature detection 501d is map matched to map road link segment 503a and a second feature point of linear feature point detection 501d is map matched to map road link segment 503b.

In one example embodiment, the singular linear features on the same link segment are further clustered by their signed distance to the link segment. The singular linear features in the same cluster will proceed for location and/or orientation estimation according to the example embodiments described herein. For example, the location module 307 clusters the two or more linear feature detections into at least one cluster group. The feature location and/or feature orientation is then determined based on the clustering. It is contemplated that any clustering algorithm can be used including but not limited to K-means clustering, DBSCAN, and/or equivalent.

In step 405, the orientation module 305 determines an orientation difference for each of the two or more linear feature detections. In one example embodiment, the orientation difference is an angle difference between each of the two or more linear feature detections 109 and a link orientation of a map matched road link segment. Then the orientation module 305 determines a feature orientation of the linear feature based on an aggregation of the orientation difference for each of the two or more linear feature detections. In one example embodiment, the aggregation can a median, average, and/or any other similar statistical metric and is weighted based on a length of each of the two or more linear feature detections.

More specifically, in one example embodiment, to perform linear feature orientation estimation for singular linear feature detections 109 on the same road link segment, the orientation module 305 can estimate the most probable orientation by a weighted average approach or equivalent statistical approach. In an example embodiment of the weighted average approach, the weight is the length of each singular linear feature detection 109. In this way, the longer the length of the linear feature detection 109, the more representative of the real-world linear feature the linear feature detection 109 should be.

However, the orientation of linear feature detections 109 is typically measured by a degree value ranged from 0-360 which measures the degree difference from due North. However, this angular metric with respect to due North can have a negative impact on accuracy when calculating a combined orientation from individual linear feature detections 109. For example, if one linear feature detection has an orientation of 5 degrees and another has 345 degrees, a simple summation divided by count (e.g., (5+345)/2=175 in this example) may not be sufficient to estimate the linear feature orientation because it does not account for a consistent driving direction of the vehicle 103 or UE 105 making the detection. For example, two different vehicles 103 may be traveling in opposite directions on a road when detecting the same linear feature which can result in the two linear detections 109 being flipped 180 degrees from each other. In the above example, when the orientation of the first linear feature detection (e.g., 5 degrees), for instance, is flipped 180 degrees in a feature direction consistent with the second linear feature detection, the resulting orientation average is 355 degrees which is what the true heading of the linear feature should be.

To address this technical problem with orientation estimation, the orientation module 305 introduces a map-based orientation aggregation into the linear feature orientation estimation. In one example embodiment, instead of aggregating the orientations of singular linear feature detections 109, the orientation module 305 aggregates the orientation difference of singular linear feature detections with respect to their map matched road link segments. For example, the orientation difference is calculated as a signed acute angle difference (e.g., ranging from −90° to) 90° between an orientation of a linear feature detection 109 (e.g., determined using sensor data of the vehicle 103 and/or UE 105) and an orientation of its map matched road link segment (e.g., as queried from the map data of the geographic database 115). The weighted median of the orientation difference of all linear features on the same link segment can be taken as the overall orientation estimation for that link segment. It is noted that a weighted median is provided by way of illustration and not as a limitation. It is contemplated that any other statistical process can be used including but not limited to a weighted average, a minimum, a maximum, a mode, etc.

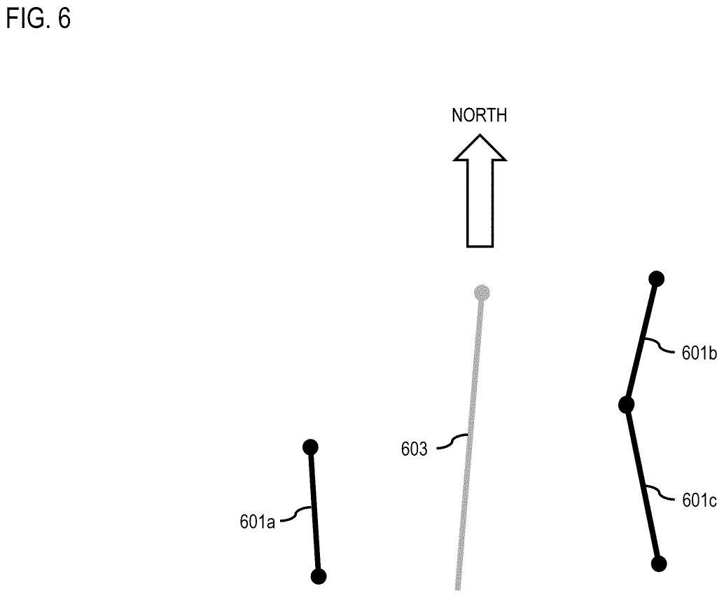

FIG. 6 is a diagram illustrating an example of linear orientation estimation, according to one example embodiment. In the example of FIG. 6, three linear feature detections 601a-601c associated with a road link segment 603 are received or otherwise determined. With respect to due North, the orientation of the linear features 601a-601c and road link segment are illustrated in Table 1 below. The orientations of the linear features 601a-601c are calculated from their respective feature point locations, and the orientation of the road link segment 603 is determined from the map data of the geographic database 115.

TABLE 1

| | ORIENTATION |
|---|---|
| Linear Feature Detection 601a | 355° |
| Linear Feature Detection 601b | 10° |
| Linear Feature Detection 601c | 350° |
| Road Link Segment 603 | 5° |

In this example, the orientation module 305 calculates the orientation difference between the orientation of each linear feature detection 601a-601c and the orientation of the map road link segment 603. The calculated orientation differences are illustrated in Table 2 below.

TABLE 2

| | ORIENTATION DIFFERENCE IN |
|---|---|
| | RELATION TO ROAD LINK SEGMENT |
| Linear Feature Detection 601a | −10° |
| Linear Feature Detection 601b | 5° |
| Linear Feature Detection 601c | −15° |

Based on the orientation difference values of Table 2, the weighted average of orientation difference between linear feature detections 601a and map is around −8° (e.g., weighted based on the length of each linear feature detection 601a-601c). In comparison, a traditional average of the raw orientation values would equal 238° (e.g., (355°+10°+350°)/3=238°).

In step 407, the location module 307 optionally determines a feature location of the linear feature based on respective locations associated with the two or more linear feature detections. In one example embodiment, the feature location is determined based on an average of respective distances of the two feature points of the two or more linear feature detections. By way of example, the average is weighted based on a length of each of the two or more linear feature detections.

More specifically, in one example embodiment of linear feature location estimation, for singular linear feature detections 109 formed by two feature points, the linear feature location estimation refers to the weighted average of signed distances from the feature points to the map link segment. Similar to various example embodiments of feature orientation estimation, the weight is the length of each singular linear feature detection 109.

In one example embodiment, the location module 307 groups the linear feature detections 109 based on corresponding linear features, and then calculates for the location of the corresponding linear features. For example, a given road link segment can have multiple linear features (e.g., left and right road boundaries, center median, lane markings, vehicle paths, etc.) that are varying distances from the centerline of the road link segment. To separate and identify different linear features represented in the linear feature detections 109 collected for a given road link segment, the location module 307 can cluster the linear feature detections 109 by distance (e.g., from a centerline of a map matched road link segment) to group the linear feature detections according to the same linear feature (e.g., same lane marking, round boundary, etc.). The clustering method can be K-means, DBSCAN, or equivalent.

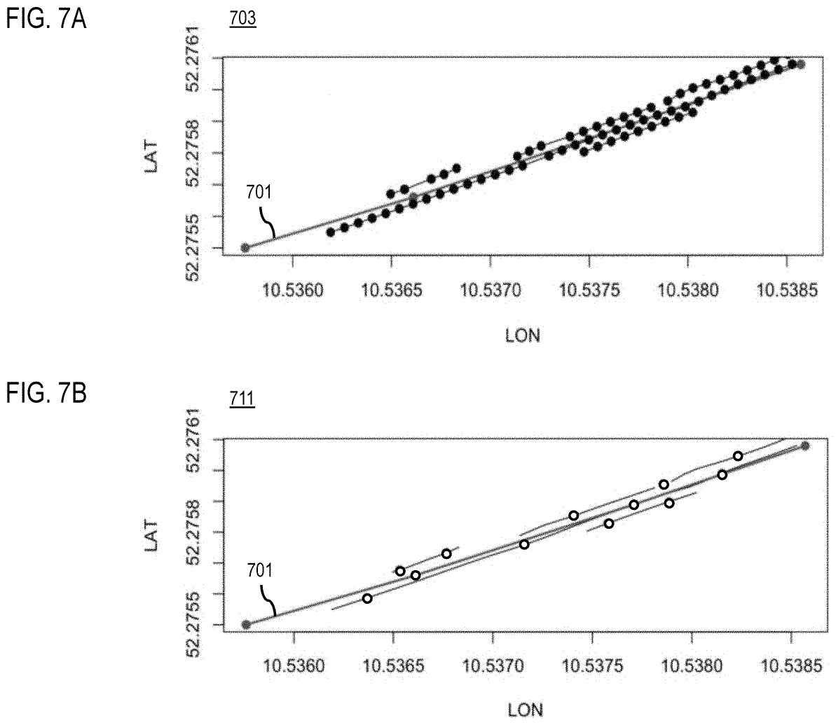

FIGS. 7A and 7B are diagrams illustrating an example of linear feature location estimation, according to one example embodiment. In the example of FIGS. 7A and 7B, linear feature detections that represent various lane markings on a road link segment 701 with multiple segments are received. In plot 703 of FIG. 7A, the original linear feature detections 705 are shown solid dots based on their respective locations (e.g., longitude on the x axis and latitude on the y axis) in relation to the position of the road link segment 701. The linear feature detections 705 are spatially clustered into multiple clusters. Then the locations are each cluster are estimated from the linear feature detections in each cluster (e.g., weighted average of the feature point locations in each cluster). The estimated feature locations are illustrated in plot 711 of FIG. 7B in which the hollow dots are the estimated locations linear features in each cluster and each segment of the road link segment 701.

In step 409, the output module 309 constructs a representation of the linear feature based at least in part on the feature orientation. For example, the output module 309 can replace the orientation of singular linear feature detections 109 with the feature orientation calculated from the aggregation of the linear feature detections 109 as described in the various example embodiments. In this way, in one example embodiment, the constructed representation of the linear feature, for instance, can be any one or more of the singular linear feature detections 109 whose orientation has been changed to the calculated feature orientation.

In another example embodiment, the representation of the linear feature is constructed further based on the feature location calculated from the aggregation of linear feature detections as described in the various example embodiments of optional step 407. In this example, the representation of the linear feature is constructed as a line through the feature location at the feature orientation. This process for constructing the linear feature representation is also referred to as linear feature generalization on each road link segment.

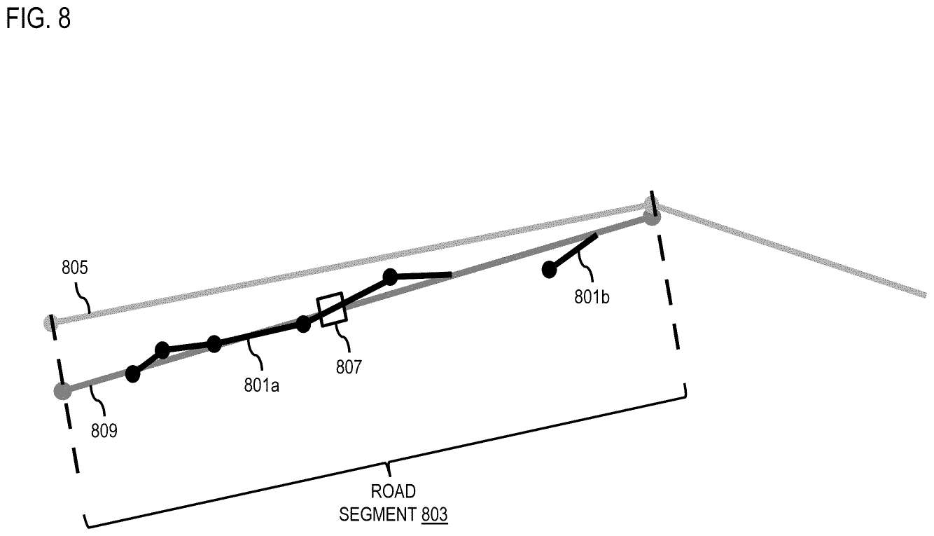

In one example embodiment, based on the orientation and/or location estimation performed according to the various example embodiments described herein, the output module 309 constructs a representation of the linear feature (e.g., represented in the linear feature detections 109) on each road link segment. The newly constructed linear feature representation retains the estimation of orientation and heading of the linear features on the same segments as illustrated in FIG. 8.

FIG. 8 is a diagram illustrating an example of constructing a representation of a linear feature based on estimated orientation and/or location data, according to one example embodiment. In the example of FIG. 8, the mapping platform 101 receives or otherwise determines linear feature detections 801a and 801b (e.g., representing lane markings or any other linear feature) associated with a road segment 803. The corresponding map road link segment 805 is retrieved from the geographic database 115 and used to perform orientation and location estimation according to the various example embodiments described herein. For example, the estimated location 807 of the linear feature is determined along with an estimated orientation of the linear feature (e.g., estimated based on the aggregated orientation differences of the linear feature detections 801a and 801b from the known orientation of the map road link segment 805). The output module 309 can then generate a newly constructed representation 809 of the linear feature by drawing a line segment through the estimated location 807 where the line segment is drawn at the estimated orientation of the linear and spans the length of the road segment 803. This reconstructed representation 809 of linear feature will advantageously:
Fill the gaps in the linear feature detections 801a and 801b (e.g., because the initial detections did not completely and continuously span the length of the road segment 803) and make the reconstructed representation 809 of the linear feature complete over the road segment 803.
Remove the inaccurate locations and orientations in the original linear feature detections 801a and 801b by substituting them with the smooth line of the newly reconstructed representation 809 of the linear feature.

In one example embodiment, the output module 309 can store the reconstructed representation of the linear feature in the geographic database 115 or equivalent map data or otherwise provide the representation of the linear feature, orientation estimation, location estimation, or a combination thereof as an output. It is contemplated that the output comprising the representation of the linear feature, orientation estimation, location estimation, or a combination thereof can be provided for use by any location-based application or service to perform a corresponding function or action based on the output. For example, any service, application, or platform (e.g., mapping platform 101, services platform 119, services 121, content providers 123, application 107, etc.) can receive or otherwise access the output of the mapping platform 101. The service, application, or function processes the newly reconstructed representation, orientation estimation, and/or location estimation of the linear feature to perform one or more location-based functions. In one example embodiment, the function includes autonomous driving based on linear features.

Another use case includes identifying a map error of the geographic database 115. In this use case, the linear feature representation generated from sensor data captured by a mapping vehicle (e.g., a vehicle 103 with high accuracy location sensors) is compared against existing map data of the geographic database 115 to identify potential discrepancies. For example, if the location and/or orientation of the newly reconstructed representation of a linear feature are not matched to previously stored linear features on a corresponding map road link or link segment thereof, then the map road link or link segment can be marked as having a potential map error. This potential map error can then be marked and presented by manual review, verification, additional map data collection, etc.

Another example use case is localizing a vehicle on a road. In this use case, the vehicle (e.g., vehicle 103) can use its computer vision system 111 to detect lane lines or other linear features so that it can localize itself within a specific lane on a road. The computer vision system 111 of a vehicle 103 generates linear feature detections 109 that are then converted linear features (e.g., lane lines). The constructed representation of the linear feature (e.g., lane line) is then matched against a specific lane data of a map road link segment based on the estimated location and/or orientation generated according to the various example embodiments described herein. Based on this matching, the vehicle 103 (e.g., via its navigation system) can determine whether the vehicle is in the correct lane to make a maneuver (e.g., making a turn, taking an upcoming exit, etc.).

These example use cases are provided by way of illustration and not as limitations. Other examples of non-limiting examples uses cases for using the output of the mapping platform 101 include, but is not limited to, providing a route for navigation (e.g., via a user interface), route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

Returning to FIG. 1, in one embodiment, the mapping platform 101 has connectivity over the communication network 117 to the services platform 119 that provides one or more services 121) (e.g., probe and/or sensor data collection services, and/or any other location-based/navigation services). By way of example, the services 121 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 119 uses the output (e.g., linear feature representations, linear feature orientation estimations, linear feature location estimations, etc.) of the mapping platform 101 to provide services such as navigation, mapping, other location-based services, etc.

In one embodiment, the mapping platform 101 may be a platform with multiple interconnected components. The mapping platform 101 may include multiple servers, intelligent networking devices, computing devices, components, and corresponding software for providing parametric representations of lane lines. In addition, it is noted that the mapping platform 101 may be a separate entity of the system 100, a part of the services platform 119, a part of the one or more services 121, or included within the vehicles 103 (e.g., an embedded navigation system).

In one embodiment, content providers 123 may provide content or data (e.g., including probe data, sensor data, etc.) to the mapping platform 101, the UEs 105, the applications 107, the geographic database 115, the services platform 119, the services 121, and the vehicles 103. The content provided may be any type of content, such as map content, textual content, audio content, video content, image content, etc. In one embodiment, the content providers 123 may provide content that may aid in reconstructing linear features of a road. In one embodiment, the content providers 123 may also store content associated with the mapping platform 101, the geographic database 115, the services platform 119, the services 121, and/or the vehicles 103. In another embodiment, the content providers 123 may manage access to a central repository of data, and offer a consistent, standard interface to data, such as a repository of the geographic database 115.

By way of example, the UEs 105 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 105 can support any type of interface to the user (such as “wearable” circuitry, etc.). In one embodiment, a UE 105 may be associated with a vehicle 103 (e.g., a mobile device) or be a component part of the vehicle 103 (e.g., an embedded navigation system). In one embodiment, the UEs 105 may include the mapping platform 101 to provide lane-level mapping/routing based on route identification information determined from unordered line data.

In one embodiment, as mentioned above, the vehicles 103, for instance, are part of a system for collecting image data and/or other sensor data (e.g., comprising line data) for linear feature reconstruction. The image data and/or linear feature detections 109 generated from image data can be reported from the vehicles 103 in real-time, in batches, continuously, or at any other frequency requested by the system 100 over, for instance, the communication network 117 for processing by the mapping platform 101. The image data and/or linear feature detections 109 also can be map matched to specific road link segments stored in the geographic database 115 according to the embodiments described herein.

In one embodiment, the vehicles 103 and/or UEs 105 are configured with various sensors for generating or collecting linear feature detections 109, image data, probe data, sensor data, related geographic/map data, etc. In one embodiment, the sensed data represents sensor data associated with a geographic location or coordinates at which the sensor data was collected. By way of example, the vehicle sensors may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 103, switch sensors for determining whether one or more vehicle switches are engaged, and the like. Though depicted as automobiles, it is contemplated the vehicles 103 can be any type of vehicle manned or unmanned (e.g., cars, trucks, buses, vans, motorcycles, scooters, drones, etc.) that travel through road segments of a road network.

Other examples of sensors of the vehicle 103 may include light sensors, orientation sensors augmented with height sensors and acceleration sensor (e.g., an accelerometer can measure acceleration and can be used to determine orientation of the vehicle), tilt sensors to detect the degree of incline or decline of the vehicle 103 along a path of travel (e.g., while on a hill or a cliff), moisture sensors, pressure sensors, etc. In a further example embodiment, sensors about the perimeter of the vehicle 103 may detect the relative distance of the vehicle 103 from a physical divider, a lane line of a link or roadway, any other linear feature of the road,), vehicle paths, the presence of other vehicles, pedestrians, traffic lights, potholes and any other objects, or a combination thereof. In one scenario, the vehicle sensors may detect weather data, traffic information, or a combination thereof. In one embodiment, the vehicles 103 may include GPS or other satellite-based receivers to obtain geographic coordinates from satellites 113 for determining current location and time. Further, the location can be determined by visual odometry, triangulation systems such as A-GPS, Cell of Origin, or other location extrapolation technologies.

In one embodiment, the UEs 105 may also be configured with various sensors (not shown for illustrative convenience) for acquiring and/or generating probe data and/or sensor data associated with a vehicle 103, a driver, other vehicles, conditions regarding the driving environment or roadway, etc. For example, such sensors may be used as GPS receivers for interacting with the one or more satellites 113 to determine and track the current speed, position, and location of a vehicle 103 travelling along a link or roadway. In addition, the sensors may gather tilt data (e.g., a degree of incline or decline of the vehicle during travel), motion data, light data, sound data, image data, weather data, temporal data and other data associated with the vehicles 103 and/or UEs 105. Still further, the sensors may detect local or transient network and/or wireless signals, such as those transmitted by nearby devices during navigation of a vehicle along a roadway (Li-Fi, near field communication (NFC)) etc.

It is noted therefore that the above-described data may be transmitted via communication network 117 as linear feature detections 109 or associated sensor data according to any known wireless communication protocols. For example, each UE 105, application 107, user, and/or vehicle 103 may be assigned a unique probe identifier (probe ID) for use in reporting or transmitting said linear feature detections 109 and/or associated sensor data collected by the vehicles 103 and/or UEs 105.

In one embodiment, the mapping platform 101 retrieves aggregated linear feature detections 109 and/or associated sensor data gathered and/or generated by the vehicle sensors and/or the UE 105 resulting from the travel of the UEs 105 and/or vehicles 103 on a road segment of a road network. In one instance, the geographic database 115 stores a plurality of linear feature detections 09 and/or associated sensor data generated by different vehicle sensors, UEs 105, applications 107, vehicles 103, etc. over a period while traveling in a monitored area.

In one embodiment, the communication network 117 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 103, mapping platform 101, UEs 105, applications 107, services platform 119, services 121, and/or content providers 123 communicate with each other and other components of the system 100 using well known, new or still developing protocols. In this context, a protocol includes a set of rules defining how the network nodes within the communication network 117 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

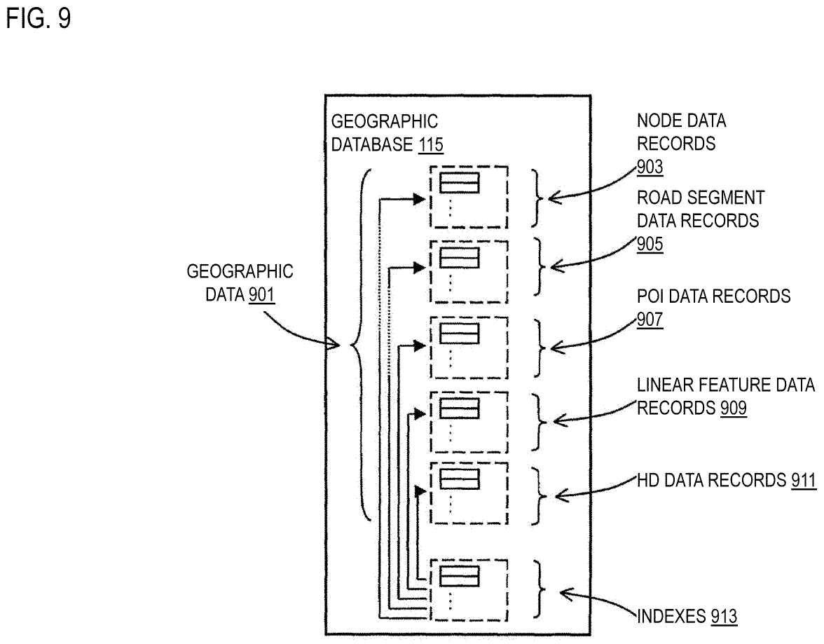

FIG. 9 is a diagram of a geographic database (such as the database 115), according to one embodiment. In one embodiment, the geographic database 115 includes geographic data 901 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on Light Detection and Ranging (LiDAR) or equivalent technology to collect billions of 3D points and model road surfaces and other map features down to the number lanes and their widths. In one embodiment, the HD mapping data (e.g., HD data records 911) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alert a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 903, road segment or link data records 905, POI data records 907, linear feature data records 909, HD mapping data records 911, and indexes 913, for example. More, fewer, or different data records can be provided. In one embodiment, additional data records (not shown) can include cartographic (“carto”) data records, routing data, and maneuver data. In one embodiment, the indexes 913 may improve the speed of data retrieval operations in the geographic database 115. In one embodiment, the indexes 913 may be used to quickly locate data without having to search every row in the geographic database 115 every time it is accessed. For example, in one embodiment, the indexes 913 can be a spatial index of the polygon points associated with stored feature polygons.

In exemplary embodiments, the road segment data records 905 are links or segments representing roads, streets, or paths, as can be used in the calculated route or recorded route information for determination of one or more personalized routes. The node data records 903 are end points (such as representing intersections, respectively) corresponding to the respective links or segments of the road segment data records 905. The road link data records 905 and the node data records 903 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 907. The geographic database 115 can also include data about places, such as cities, towns, or other communities, and other geographic features, such as bodies of water, mountain ranges, etc. Such place or feature data can be part of the POI data records 907 or can be associated with POIs or POI data records 907 (such as a data point used for displaying or representing a position of a city).

In one embodiment, the geographic database 115 can also include linear feature data records 909 for storing the constructed linear feature representations, linear feature detections 109, linear feature orientations, linear feature locations, and/or any other data generated or used by the system 100 according to the various embodiments described herein. By way of example, the linear feature data records 909 can be associated with one or more of the node records 903, road segment records 905, and/or POI data records 907 to support autonomous driving or other location-based applications based on the features stored therein. In this way, the linear feature data records 909 can also be associated with or used to classify the characteristics or metadata of the corresponding records 903, 905, and/or 907.

In one embodiment, as discussed above, the HD mapping data records 911 model road surfaces and other map features to centimeter-level or better accuracy. The HD mapping data records 911 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 911 are divided into spatial partitions of varying sizes to provide HD mapping data to vehicles 103 and other end user devices with near real-time speed without overloading the available resources of the vehicles 103 and/or devices (e.g., computational, memory, bandwidth, etc. resources).

In one embodiment, the HD mapping data records 911 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 911.

In one embodiment, the HD mapping data records 911 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content provider 123 in association with the services platform 119 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles 103 and/or UEs 105) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 103 or a UE 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for reconstructing road linear features may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

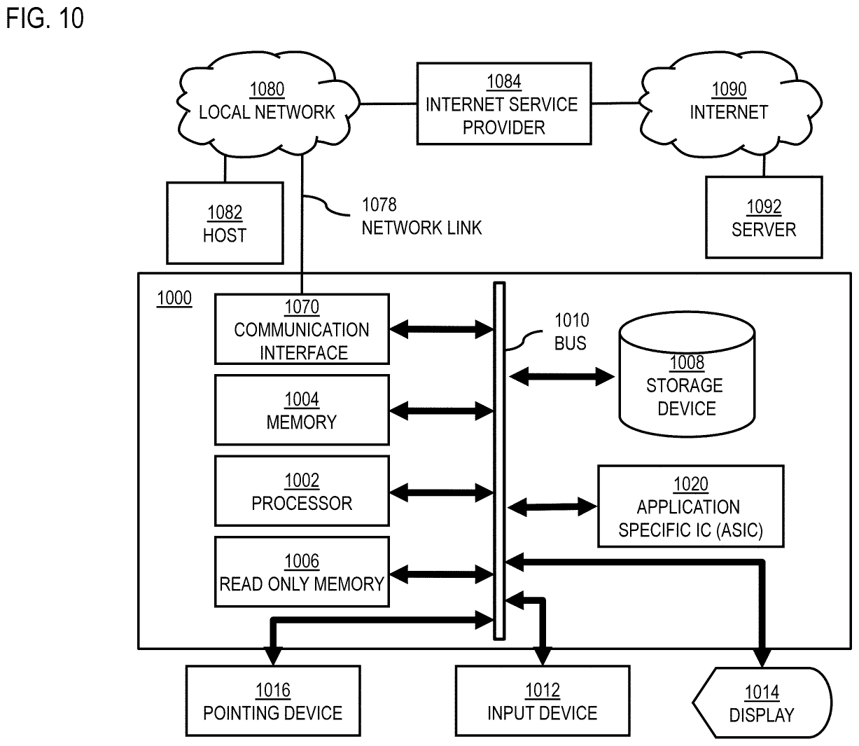

FIG. 10 illustrates a computer system 1000 upon which an embodiment of the invention may be implemented. Computer system 1000 is programmed (e.g., via computer program code or instructions) to reconstruct road linear features as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1010 includes one or more parallel conductors of information so that information is transferred quickly among devices coupled to the bus 1010. One or more processors 1002 for processing information are coupled with the bus 1010.

A processor 1002 performs a set of operations on information as specified by computer program code related to reconstructing road linear features. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or other dynamic storage device, stores information including processor instructions for reconstructing road linear features. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for reconstructing road linear features, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 117 for reconstructing road linear features.

The term computer-readable medium is used herein to refer to any medium that participates in providing information to processor 1002, including instructions for execution. Such a medium may take many forms, including, but not limited to, non-volatile media, volatile media and transmission media. Non-volatile media include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system can be deployed in various configurations within other computer systems, e.g., host 1082 and server 1092.

FIG. 11 illustrates a chip set 1100 upon which an embodiment of the invention may be implemented. Chip set 1100 is programmed to reconstruct road linear features as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to reconstruct road linear features. The memory 1105 also stores the data associated with or generated by the execution of the inventive steps.

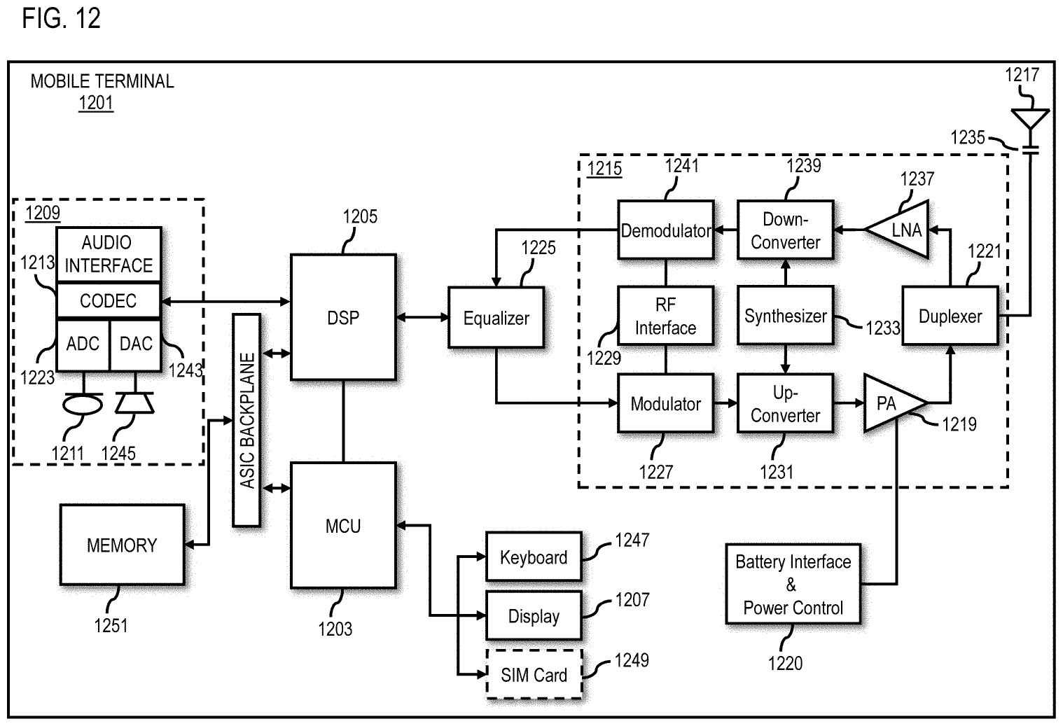

FIG. 12 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile station functions that offer automatic contact matching. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile station 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile station 1201 to reconstruct road linear features. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the station. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile station 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1251 may be, but not limited to, a single memory, CD, DVD, ROM, RAM, EEPROM, optical storage, or any other non-volatile or non-transitory storage medium capable of storing digital data.

An optionally incorporated SIM card 1249 carries, for instance, important information, such as the cellular phone number, the carrier supplying service, subscription details, and security information. The SIM card 1249 serves primarily to identify the mobile station 1201 on a radio network. The card 1249 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
receiving two or more linear feature detections that respectively represent a linear feature of a road as a line segment delimited by two feature points;
map matching the two or more linear feature detections to a road link segment of a geographic database;
determining an orientation difference for each of the two or more linear feature detections, wherein the orientation difference is an angle difference between each of the two or more linear feature detections and a link orientation of the map matched road link segment;
determining a feature orientation of the linear feature based on an aggregation of the orientation difference for each of the two or more linear feature detections; and
constructing a representation of the linear feature based at least in part on the feature orientation.

2. The method of claim 1, wherein the aggregation is weighted based on a length of each of the two or more linear feature detections.

3. The method of claim 1, wherein the orientation difference is a signed acute angle difference.

4. The method of claim 1, wherein the aggregation is a median or an average.

5. The method of claim 1, further comprising:
determining a feature location of the linear feature based on respective locations associated with the two or more linear feature detections.

6. The method of claim 5, wherein the representation of the linear feature is constructed further based on the feature location.

7. The method of claim 5, wherein the representation of the linear feature is constructed as a line through the feature location at the feature orientation.

8. The method of claim 5, wherein the feature location is determined based on an average of respective distances of the two feature points of the two or more linear feature detections.

9. The method of claim 8, wherein the average is weighted based on respective lengths of the two or more linear feature detections.

10. The method of claim 5, further comprising:
clustering the two or more linear feature detections into at least one cluster group,
wherein the feature location is determined based on the clustering.

11. The method of claim 1, wherein the linear feature is a road boundary, a road lane marking, a road median, a road curb, a line-based road object, a vehicle path, or a combination thereof.

12. An apparatus comprising:
at least one processor; and
at least one memory including computer program code for one or more programs,
the at least one memory and the computer program code configured to, within the at least one processor, cause the apparatus to perform at least the following,
receive two or more linear feature detections that respectively represent a linear feature of a road as a line segment delimited by two feature points;
map match the two or more linear feature detections to a road link segment of a geographic database;
determine an orientation difference for each of the two or more linear feature detections, wherein the orientation difference is an angle difference between each of the two or more linear feature detections and a link orientation of the map matched road link segment;
determine a feature orientation of the linear feature based on an aggregation of the orientation difference for each of the two or more linear feature detections; and
construct a representation of the linear feature based at least in part on the feature orientation.

13. The apparatus of claim 12, wherein the aggregation is weighted based on a length of each of the two or more linear feature detections.

14. The apparatus of claim 12, wherein the apparatus is further caused to:
determine a feature location of the linear feature based on respective locations associated with the two or more linear feature detections.

15. The apparatus of claim 14, wherein the representation of the linear feature is constructed further based on the feature location.

16. The apparatus of claim 14, wherein the representation of the linear feature is constructed as a line through the feature location at the feature orientation.

17. A non-transitory computer-readable storage medium carrying one or more sequences of one or more instructions which, when executed by one or more processors, cause an apparatus to perform:
receiving two or more linear feature detections that respectively represent a linear feature of a road as a line segment delimited by two feature points;
map matching the two or more linear feature detections to a road link segment of a geographic database;
determining an orientation difference for each of the two or more linear feature detections, wherein the orientation difference is an angle difference between each of the two or more linear feature detections and a link orientation of the map matched road link segment;
determining a feature orientation of the linear feature based on an aggregation of the orientation difference for each of the two or more linear feature detections; and
constructing a representation of the linear feature based at least in part on the feature orientation.

18. The non-transitory computer-readable storage medium of claim 17, wherein the aggregation is weighted based on a length of each of the two or more linear feature detections.

19. The non-transitory computer-readable storage medium of claim 17, wherein the apparatus is caused to further perform:
determining a feature location of the linear feature based on respective locations associated with the two or more linear feature detections.

20. The non-transitory computer-readable storage medium of claim 19, wherein the representation of the linear feature is constructed further based on the feature location.
